(19) United States
(12) Patent Application Publication
(10) Pub. No.: US 2025/0249773 A1
(43) Pub. Date: Aug. 7, 2025

(54) ELECTRIC VEHICLE CHARGING SYSTEM AND METHOD OF OPERATING THE SAME

(71) Applicant: ADDÉNERGIE TECHNOLOGIES INC., Québec City (CA)

(72) Inventors: Simon DUGRÉ, Québec City (CA); Jean Gérard BIZOUARD, Québec City (CA); Léonard GAGNON, Quebec City (CA)

(73) Assignee: ADDÉNERGIE TECHNOLOGIES INC., Québec City (CA)

(21) Appl. No.: 18/434,023

(22) Filed: Feb. 6, 2024

(51) Int. Cl. B60L 53/62; B60L 53/10; B60L 53/53; B60L 53/66; B60L 53/67

(52) U.S. Cl. CPC B60L 53/62; B60L 53/11; B60L 53/53; B60L 53/66; B60L 53/67; B60L 2240/54

(57) ABSTRACT

An electric vehicle (EV) charging system comprises at least a first EV charging station that includes at least a first EV charger and at least one power bank associated with the first EV charger at least one electrical contactor matrix associated with the first EV charger and selectively coupling the first EV charger to the at least one power bank associated with the first EV charger and to at least one other power source; and a controller associated with the first EV charger, the controller configured to determine that the first EV charger requires a greater amount of power than can be provided by the at least one power bank associated with the first EV charger; identify the at least one other power source as available for use; and communicate a signal to divert power from the at least one other power source to the first EV charger.

### FIELD

This application relates to an electric vehicle charging system and a method of operating the same.

### BACKGROUND

An electric vehicle (EV) charging station is an element of infrastructure that supplies direct current (DC) or alternating current (AC) electric energy for the recharging of electric vehicles, such as plug-in battery electric vehicles, including electric cars, trucks, buses, and other vehicles including high and low range electric vehicles and plug-in hybrids. An EV charging station may be referred to as an Electric Vehicle Supply Equipment (EVSE).

Electric vehicle users often wish to rapidly charge such vehicles and, in order to accommodate such users, some EV charging stations are high-voltage charging stations which deliver high power to the electric vehicle during charging. For example, some chargers, which are often referred to as level 3 or Direct Current Fast Chargers (DCFC) may deliver up to 250 kW of power at around 400 VDC. Even faster charging is possible with yet higher voltage and power capabilities.

Oftentimes, the usage of EV charging stations is inefficient since one or more power banks and/or power modules of the EV charging station may go unused.

### BRIEF DESCRIPTION OF THE DRAWINGS

Embodiments are described in detail below, with reference to the following drawings:

FIG. 1 is a perspective view of an electric vehicle (EV) charging system of an example embodiment;

FIG. 2 is a simplified schematic diagram showing various components of an EV charging station;

FIG. 3 is another simplified schematic diagram of the EV charging station of FIG. 2;

FIG. 4 is an example flowchart showing operations performed in accordance with a method for diverting power;

FIG. 5 is another simplified schematic diagram of the EV charging station of FIG. 2;

FIG. 6 is an example flowchart showing operations performed in accordance with a method for diverting power back to a second EV charger;

FIG. 7 is another simplified schematic diagram of an EV charging station;

FIG. 8 is a simplified schematic diagram of another EV charging system;

FIG. 9 is another simplified schematic diagram of the EV charging system of FIG. 8;

FIG. 10 is a simplified schematic diagram of another EV charging system;

FIG. 11 is a simplified schematic diagram showing various components of a remote power cabinet; and

FIG. 12 is a high-level operation diagram of an example EV charging station.

Like reference numerals are used in the drawings to denote like elements and features.

### DETAILED DESCRIPTION OF EXAMPLE EMBODIMENTS

Accordingly, in one aspect there is provided an electric vehicle (EV) charging system comprising at least a first EV charging station that includes at least a first EV charger and at least one power bank associated with the first EV charger; at least one electrical contactor matrix associated with the first EV charger and selectively coupling the first EV charger to the at least one power bank associated with the first EV charger and to at least one other power source; and a controller associated with the first EV charger, the controller configured to determine that the first EV charger requires a greater amount of power than can be provided by the at least one power bank associated with the first EV charger; identify the at least one other power source as available for use; and communicate a signal to divert power from the at least one other power source to the first EV charger.

In one or more embodiments, the at least one other power source includes at least one of an internal power source or an external power source.

In one or more embodiments, the external power source includes at least one of a power bank of at least one other EV charging station or a power bank of a remote power cabinet.

In one or more embodiments, the first EV charging station includes at least one other power bank associated with the first EV charger and the at least one other power source includes the at least one other power bank associated with the first EV charger.

In one or more embodiments, the first EV charging station includes at least a second EV charger and at least one power bank associated with the second EV charger and the at least one other power source includes the at least one power bank associated with the second EV charger.

In one or more embodiments, when identifying the at least one other power source as available for use, the controller is configured to determine that the at least one power bank associated with the second EV charger is available for use; and communicate a signal to a controller associated with the second EV charger to cause at least one electrical contactor matrix associated with the second EV charger to divert power from the at least one power bank associated with the second EV charger to the first EV charger

In one or more embodiments, the system further comprises at least a second EV charging station that includes at least a third EV charger and at least one power bank associated with the third EV charger and the at least one other power source includes the at least one power bank associated with the third EV charger.

In one or more embodiments, the second EV charging station includes at least a fourth EV charger and at least one power bank associated with the fourth EV charger and the at least one other power source includes the at least one power bank associated with the fourth EV charger.

In one or more embodiments, when identifying the at least one other power source as available for use, the controller is configured to determine that the at least one power bank associated with the second EV charger is not available for use; determine that at least one power bank associated with the third EV charger is available for use; and communicate a signal to a controller associated with the third EV charger to cause at least one electrical contactor matrix associated with the third EV charger to divert power from the at least one power bank associated with the third EV charger to the first EV charger.

In one or more embodiments, when identifying the at least one other power source as available for use, the controller is configured to analyze the first EV charging station to determine that one or more other power banks within the first EV charging station are available for use.

In one or more embodiments, wherein when identifying the at least one other power source as available for use, the controller is configured to maintain an ordered list of other power sources available for the first EV charger and to consult the ordered list to identify the at least one other power source as available for use.

In one or more embodiments, the ordered list defines a hierarchy of power banks available to the first EV charger.

In one or more embodiments, when determining that the first EV charger requires the greater amount of power than can be provided by the at least one power bank associated with the first EV charger, the controller is configured to communicate with a connected EV to obtain battery statistics of the EV; determine a maximum power for charging the EV based on the battery statistics of the EV; and determine that the maximum power for charging the EV is greater than an amount of power that can be provided by the at least one power bank associated with the first EV charger.

In one or more embodiments, the first EV charger has priority to the at least one power bank associated with the first EV charger.

According to another aspect there is provided a method comprising: determining that a first electric vehicle (EV) charger of a first EV charging station requires a greater amount of power than can be provided by at least one power bank associated with the first EV charger; identifying at least one other power source as available for use; and communicating a signal to divert power from the at least one other power source to the first EV charger.

In one or more embodiments, the first EV charging station includes at least one other power bank associated with the first EV charger and the at least one other power source includes the at least one other power bank associated with the first EV charger.

In one or more embodiments, when identifying the at least one other power source as available for use, the method further comprises determining that at least one power bank associated with a second EV charger of the first EV charging station is available for use; and communicate a signal to a controller associated with the second EV charger to cause at least one electrical contactor matrix associated with the second EV charger to divert power from the at least one power bank associated with the second EV charger to the first EV charger.

In one or more embodiments, when identifying the at least one other power source as available for use, the method further comprises determining that at least one power bank associated with a second EV charger of the first EV charging station is not available for use; determining that at least one power bank associated with a third EV charger of a second EV charging station is available for use; and communicate a signal to a controller associated with the third EV charger to cause at least one electrical contactor matrix associated with the third EV charger to divert power from the at least one power bank associated with the third EV charger to the first EV charger.

In one or more embodiments, when identifying the at least one other power source as available for use, the method further comprises analyzing the first EV charging station to determine that one or more other power banks within the first EV charging station are available for use.

In one or more embodiments, the method further comprises consulting an ordered list of other power sources available for the first EV charger to identify the at least one other power source as available for use.

In the present application, the term “and/or” is intended to cover all possible combinations and sub-combinations of the listed elements, including any one of the listed elements alone, any sub-combination, or all of the elements, and without necessarily excluding additional elements.

In the present application, the phrase “at least one of . . . or . . . ” is intended to cover any one or more of the listed elements, including any one of the listed elements alone, any sub-combination, or all of the elements, without necessarily excluding any additional elements, and without necessarily requiring all of the elements.

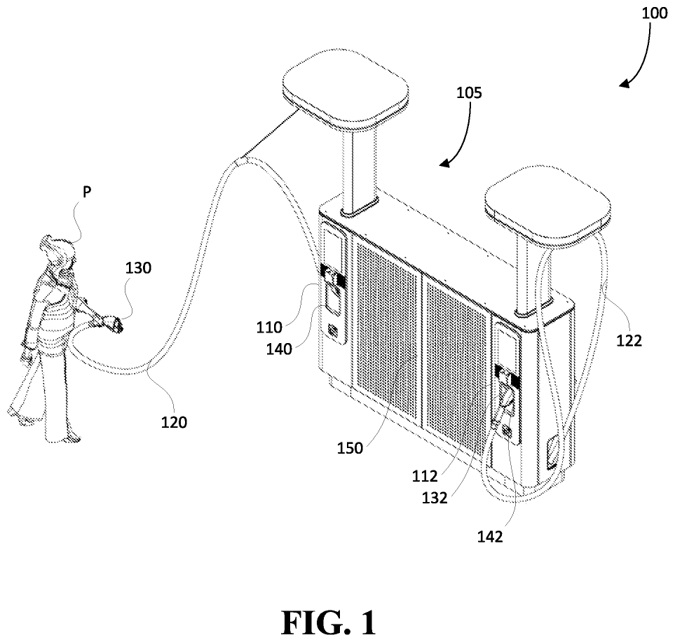

Reference is made to FIG. 1, which illustrates an electric vehicle (EV) charging system 100 that may include one or more EV charging stations. The EV charging stations are monolithic EV charging stations. In the illustrated example, the EV charging system 100 includes a single or first EV charging station 105. In other implementations, the EV charging system 100 may include a greater number of EV charging stations 105. For example, in one or more embodiments, the EV charging system 100 may include a first EV charging station and a second EV charging station. As another example, in one or more embodiments, the EV charging system 100 may include a first EV charging station, a second EV charging station, and a third EV charging station.

The EV charging station 105 may operate according to one or more standards such as for example the SAE J1772 standard and/or the SAE J3400 standard.

The EV charging station 105 may include one or more EV chargers. In the illustrated example, the EV charging station 105 includes two EV chargers—a first EV charger 110 and a second EV charger 112. In other implementations, the EV charging station 105 may include a greater or lesser number of EV chargers than the EV charging station 105 of FIG. 1.

Each of the EV chargers 110, 112 may allow the EV charging station 105 to concurrently charge a separate electric vehicle. For example, an EV charging station 105 having two EV chargers may concurrently charge two electric vehicles, an EV charging station 105 having three EV chargers may concurrently charge three EVs, and so on. As will be described in more detail below, in one or more embodiments power may be borrowed or shared between different EV chargers and/or different EV charging stations.

The EV chargers may be of various types including, for example, Level 3 chargers and/or Level 4 chargers. In one implementation, the EV charging station 105 may include an EV charger that charges an EV at a range of 200V to 500V or more.

The EV charging station 105 may be installed at any one or more of: a residence, a business, a parking facility, or in an operating environment of another type. In at least one implementation, the EV charging station may be a roadside EV charging station.

Each of the EV chargers 110, 112 may include a charging cable. For example, a first EV charger 110 may include a first charging cable 120 and a second EV charger 112 may include a second charging cable 122.

Each of the charging cables 120, 122 may, at one end, include a connector 130, 132. For example, the first charging cable 120 may include a first connector 130 and the second charging cable 122 may include a second connector 132. The first and second connectors 130, 132 may be of the same type or of different types. The connectors 130, 132 are configured to connect the EV chargers to an electric vehicle. More specifically, the connectors 130, 132 are configured to mate with a charging port of an electric vehicle. The connectors 130, 132 may be configured according to standards such as, for example CHAdeMO standards and/or SAE Combo standards. In some implementations, the connectors 130, 132 may be of one or more of the connectors defined in IEC 62196-3 standard, SAE J1772, SAE J3400, CHAdeMO, etc.

An operator P may use the EV charging station 105 to charge an electric vehicle by extending one of the charging cables 120, 122 until one of the connectors 130, 132 can be aligned with the charging port of the electric vehicle. Then, the operator P may plug the connector 130, 132 into the charging port and the EV charger 110, 112 will initiate charging of a battery of the electric vehicle.

Each EV charger 110, 112 may include a holster 140, 142 or other holder for holding an associated connector 130, 132 off the ground when an EV charger is not in use. The holster 140, 142 may serve to protect the EV charger 110, 112 from damage due to environmental factors, such as rain, snow, etc. Additionally or alternatively, the holster 140, 142 may serve to protect the EV charger 110, 112 from accidental damage from, for example, inadvertent contact with vehicles. The holster 140, 142 may, additionally or alternatively, hold the connector 130, 132 at a height that makes it more accessible. For example, the EV charger 110, 112 may hold the connector 130, 132 off of the ground at a height above the ground that makes it easy for the operator to grab the connector 130, 132 without having to bend. The holster 140, 142 may, in at least some implementations, hold the connector 130, 132 at a height above the ground that allows an operator in a wheelchair to easily grab the holster 140, 142.

The EV charging station 105 includes a power cabinet 150 that houses and includes various components of the EV charging station 105 such as for example power conversion and supply circuitry. In one or more embodiments, the various components may include at least one power bank, at least one power module and at least one electrical contactor matrix. The at least one power bank may include the at least one power module and each power bank may include any number of power modules. For example, a power bank may include a single power module. As another example, a power bank may include two power modules that may be referred to as a set of power modules.

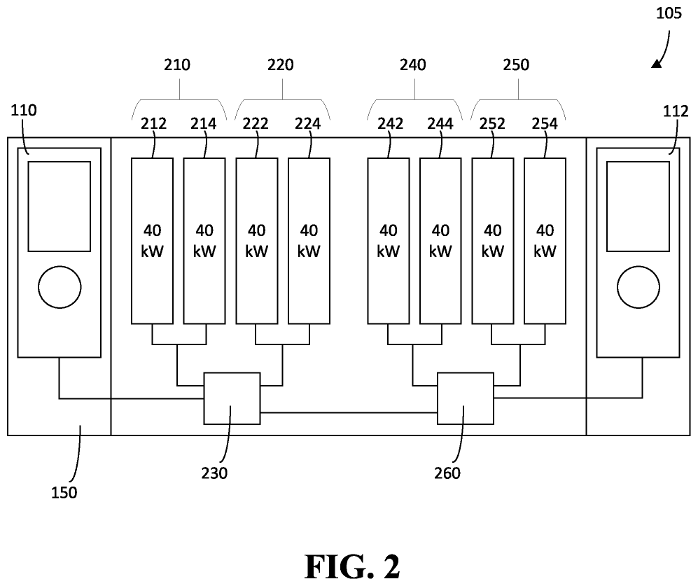

FIG. 2 is a simplified schematic diagram showing various components of the EV charging station 105 housed within the power cabinet 150 according to an example embodiment. In the example shown, the components of the EV charging station 105 include a first power bank 210, a second power bank 220, a first electrical contactor matrix 230, a third power bank 240, a fourth power bank 250, and a second electrical contactor matrix 260. The EV chargers 110, 112 are also shown.

The first power bank 210 includes power modules 212, 214. As shown, in this example, each power module 212, 214 is capable of providing 40 kW of power.

The second power bank 220 includes power modules 222, 224. As shown, in this example, each power module 222, 224 is capable of providing 40 kW of power.

The first electrical contactor matrix 230 may include multiple electrical contactors that may be configured to selectively electrically couple power banks as required. The first electrical contactor matrix 230 may include one or more DC ports. It will be appreciated that the first electrical contactor matrix 230 may perform switching patterns to selectively electrically couple the power banks at the request of one or more controllers. It will be appreciated that safety validation may be performed by the first electrical contactor matrix 230 to ensure safety rules and/or safety standards are not violated. For example, a hardware and/or software interlock circuit may be used to prevent connecting two EV chargers to the same power bank. T

The third power bank 240 includes power modules 242, 244. As shown, in this example, each power module 242, 244 is capable of providing 40 kW of power.

The fourth power bank 250 includes power modules 252, 254. As shown, in this example, each power module 252, 254 is capable of providing 40 kW of power.

The second electrical contactor matrix 260 may include multiple electrical contactors that may be configured to selectively electrically couple power banks as required. The second electrical contactor matrix 260 may include one or more DC ports. It will be appreciated that the second electrical contactor matrix 260 may perform switching patterns to selectively electrically couple the power banks at the request of one or more controllers. It will be appreciated that safety validation may be performed by the second electrical contactor matrix 260 to ensure safety rules and/or safety standards are not violated. For example, a hardware and/or software interlock circuit may be used to prevent two EV chargers of connecting to the same power bank. The first electrical contactor matrix 230 and the second electrical contactor matrix 260 are controlled separately by their associated controllers. For example, the first electrical contactor matrix 230 is controlled by a first controller which may include a controller of the EV charger 110. The second electrical contactor matrix 260 is controlled by a second controller which may include a controller of the EV charger 112. As shown in FIG. 2, the first electrical contactor matrix 230 and the second electrical contactor matrix 260 may be electrically interconnected or coupled. Through use of the first electrical contactor matrix 230 and the second electrical contactor matrix 260 and the associated controllers, the EV charging system 100 may propagate a shutdown signal to all power banks involved in a charge and this may be done for safety reasons. Put another way, through use of the first electrical contactor matrix 230 and the second electrical contactor matrix 260 and the associated controllers, the EV charging system 100 is able to route a shutdown signal to the correct power banks to ensure safe switching.

The EV chargers 110, 112 are dispensers which dispense or otherwise supply power from one or more power banks and/or one or more power modules to an EV which connects via one of the charging cables 120, 122.

In one or more embodiments, one or more power banks within the EV charging station 105 may be associated with the EV chargers 110, 112 and vice versa. A power bank associated with an EV charger may provide the EV charger with priority access thereto. Put another way, an EV charger that is associated with a power bank may have priority access to the power bank. For example, the EV charger 110 may be associated with the first power bank 210 and the second power bank 220. As a result, the EV charger 110 may be provided with priority access to the first power bank 210 and the second power bank 220. Similarly, the EV charger 112 may be associated with the third power bank 240 and the fourth power bank 250. As a result, the EV charger 112 may be provided with priority access to the third power bank 240 and the fourth power bank 250. As will be described in more detail, an ordered list may be maintained that defines a priority or hierarchy for the EV chargers and/or the power banks within the EV charging station 105.

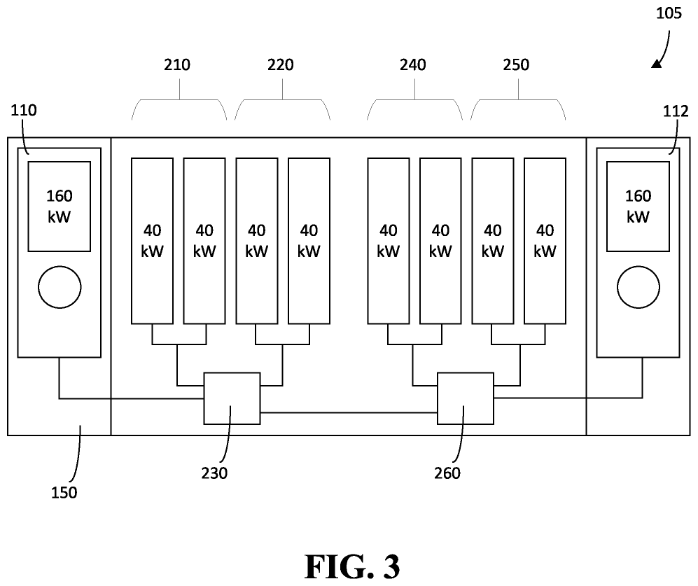

During operation, the EV charger 112 and the EV charger 114 may access power from the power banks they have priority access to. An example is shown in FIG. 3. In this example, the first electrical contactor matrix 230 may electrically couple the EV charger 112 to the first power bank 210 and the second power bank 220. As a result, the EV charger 110 may dispense or otherwise supply power to a connected EV up to a maximum of 160 kW. Similarly, the second electrical contactor matrix 260 may electrically couple the EV charger 112 to the third power bank 240 and the fourth power bank 250. As a result, the EV charger 112 may dispense or otherwise supply power to a connected EV up to a maximum of 160 kW.

During times when one or more power banks are unused, operations may be performed to cause at least one electrical contactor matrix to divert power from the one or more power banks that are currently unused to maximize the amount of power dispensed or otherwise provided to a connected EV. As will be described, this may be performed automatically by one or more controllers of the EV charging station.

As will be described, power may be diverted from one or more internal power sources and/or one or more external power sources. An internal power source may refer to one or more power banks within the same EV charging station as the EV charger requiring additional power. An external power source may refer to one or more power banks outside of the EV charging station that houses the EV charger requiring additional power. Example external power sources may include power banks of one or more other EV charging stations and/or power banks of one or more remote power cabinets.

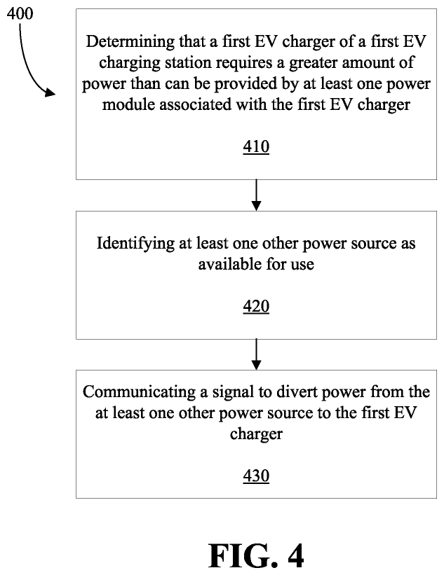

Reference is made to FIG. 4, which illustrates, in flowchart form, a method 400 for diverting power. The method 400 may be implemented by a computing device having suitable processor-executable instructions for causing the computing device to carry out the described operations. The method 400 may be implemented, in whole or in part, by one or more controllers of an EV charging system and/or one or more controllers of an EV charging station.

The method 400 includes determining that a first EV charger of a first EV charging station requires a greater amount of power than can be provided by at least one power bank associated with the first EV charger (step 410).

In one or more embodiments, the first EV charger may include the EV charger 110 and the first EV charging station may include the EV charging station 105 described herein. The at least one power bank associated with the first EV charger may include the first power bank 210 and/or the second power bank 220.

In determining that the first EV charger requires the greater amount of power than can be provided by the at least one power bank associated with the first EV charger, the controller may be configured to perform the following operations.

The controller may detect that the EV has connected to the first EV charger. For example, the EV may connect to the first EV charger via a first charging cable. In response, the controller and the EV may perform a handshake to establish a communication link.

Once the communication link has been established, the EV identifies itself to the controller and provides information such as for example the type, the model, and one or more battery statistics. The one or more battery statistics may include a state of charge, a maximum current, a battery voltage, and/or a maximum voltage. In this manner, the controller obtains battery statistics of the EV.

In one or more embodiments, the controller may determine that the EV is capable of charging at a higher rate or is able to receive a greater amount of power than can be provided by the at least one power bank associated with the first EV charger and this may be done based on the battery statistics received from the EV.

In one or more embodiments, the controller may determine a maximum power for charging the EV based on the battery statistics of the EV. For example, the controller may calculate the maximum power for charging the EV based at least on the state of charge of the EV.

The controller may compare the maximum power for charging the EV to the amount of power that can be provided by the at least one power bank associated with the first EV charger. The controller may determine that the maximum power for charging the EV is less than the amount of power that can be provided by the at least one power bank associated with the first EV charger and as such may charge the EV using the at least one power bank associated with the first EV charger.

The controller may, however, determine that the maximum power for charging the EV is greater than the amount of power than can be provided by the at least one power bank associated with the first EV charger and as such may determine that the first EV charger requires a greater amount of power than can be provided by the at least one power bank associated with the first EV charger.

The method 400 includes identifying at least one other power source as available for use (step 420).

The at least one other power source may include an internal power source or an external power source. For example, an internal power source may include one or more power banks within the first EV charging station. As another example, an external power source may include at least one of a power bank of at least one other EV charging station or a power bank of a remote power cabinet.

The controller identifies at least one other power source as available for use. The at least one other power source may include, for example, at least one power bank currently not being used to charge an EV. For example, the at least one other power source may include at least one other power bank associated with the first EV charger or may include at least one power bank associated with a second EV charger within the same EV charging station of the first EV charger.

In embodiments where the first EV charger includes the EV charger 110 and the first EV charging station includes the EV charging station 105, the at least one power bank associated with the first EV charger may include the first power bank 210 and/or the second power bank 220. In these embodiments, the at least one other power source available for use may include at least one of the third power bank 240 and/or the fourth power bank 250. In these embodiments, the power banks 240 and 250 may be associated with a second EV charger that may include the EV charger 112 of the EV charging station 105.

In one or more embodiments, in identifying at least one other power source as available for use, the controller may consult an ordered list of other power sources available for the first EV charger. The ordered list may define a hierarchy of power banks available to the first EV charger. For example, the ordered list may define a list of other power sources available to the first EV charger. In identifying the at least one other power source, the controller may consult the ordered list to select a first other power source. The controller may determine that the first other power source is not available for use and as such may consult the ordered list to select a second other power source. The controller may continue to consult the ordered list until a power source has been identified as available.

In embodiments where the first EV charger includes the EV charger 110 and the first EV charging station includes the EV charging station 105, the ordered list may include the power banks associated with the first EV charger as the first other power sources and may include the power banks associated with the second EV charger as the second other power sources. The controller may determine that the first EV charger is providing power from the power banks 210 and 220 and may determine that the first EV charger requires a greater amount of power than can be provided by the power banks 210 and 220. The controller may consult the ordered list and may determine that the next other power source listed for the first EV charger is the power banks of the second EV charger, which may include the EV charger 112, within the same first EV charging station 105. As such, the controller may determine that at least one of the power banks 240 and 250 are available for use by determining that the at least one of the power banks 240 and 250 are not currently being used.

The method 400 includes communicating a signal to divert power from the at least one other power source to the first EV charger (step 430).

Responsive to identifying the at least one other power source as available for use, the controller communicates a signal to initiate a switching pattern to electrically couple the at least one other power source to the first EV charger.

In embodiments where the first EV charger includes the EV charger 110 and the first EV charging station includes the EV charging station 105 and where the controller determines that at least one of the power banks 240 and 250 are available for use, the controller may send a signal to a controller of the EV charger 112. The signal may cause the controller of the EV charger 112 to cause the second electrical contactor matrix 260 to execute a switching pattern to electrically couple the at least one of the power banks 240 and 250 to the EV charger 110. As a result, power is diverted from the at least one of the power banks 240 and 250 to the EV charger 110.

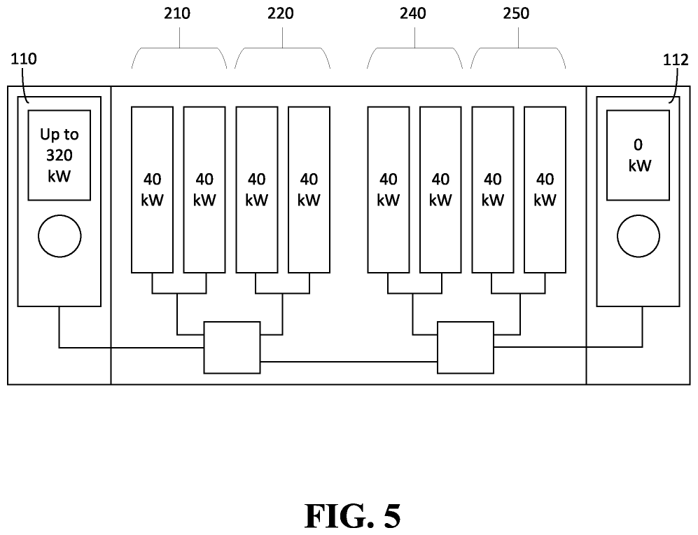

An example is shown in FIG. 5. As can be seen, the EV charger 110 is able to provide power up to 320 kW. Since the additional power has been diverted from the power banks 240 and 250 that are associated with the second EV charger 112, the second EV charger 112 is not able to deliver any power.

As mentioned, a power bank associated with an EV charger may provide the EV charger with priority access thereto. Put another way, an EV charger that is associated with a power bank may have priority access to that power bank. As such, should the second EV charger be connected to an EV while the power banks 240 and 250 are currently providing power to the first EV charger, the controller of the second EV charger may perform operations to divert the power from the power banks 240 and 250 back to the second EV charger.

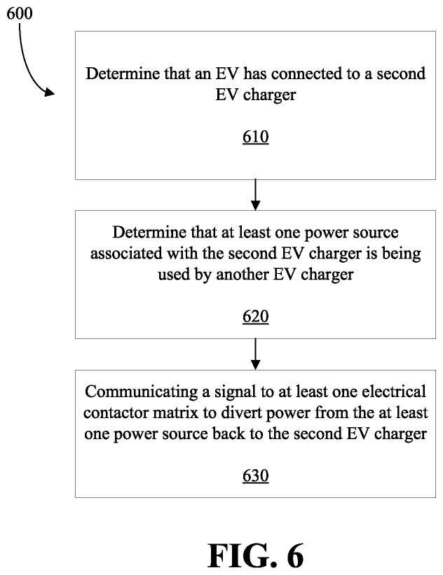

Reference is made to FIG. 6, which illustrates, in flowchart form, a method 600 for diverting power back to a second EV charger. The method 600 may be implemented by a computing device having suitable processor-executable instructions for causing the computing device to carry out the described operations. The method 600 may be implemented, in whole or in part, by one or more controllers of an EV charging system and/or one or more controllers of an EV charging station. For example, the controller of the second EV charger may implement the method 600.

The method 600 includes determining that an EV has connected to the second EV charger (step 610).

The controller may detect that an EV has connected to the second EV charger. For example, the EV may connect to the second EV charger 112 via a second charging cable 122. In response, the controller and the EV may perform a handshake to establish a communication link.

Once the communication link has been established, the EV identifies itself to the controller and provides information such as for example the type, the model, and battery statistics of the EV.

The method 600 includes determining that at least one power source associated with the second EV charger is being used by another EV charger (step 620).

The controller may analyze the EV charging station to determine one or more power sources associated with the second EV charger. For example, the controller may determine that the power banks 240 and 250 are currently being used by the first EV charger 110. Since the EV charger 112 is associated with the power banks 240 and 250, the EV charger 112 has priority access to the power banks 240 and 250.

The method 600 includes communicating a signal to at least one electrical contactor matrix to divert power from the at least one power source back to the second EV charger (step 630).

Responsive to determining that at least one power source associated with the second EV charger is being used by another EV charger, the controller communicates a signal to the at least one electrical contactor matrix. In response, the at least one electrical contactor matrix executes a switching pattern to electrically couple the at least one other power source to the second EV charger. For example, the second electrical contactor matrix 260 may execute a switching pattern to electrically couple the power banks 240 and 250 to the EV charger 112. As a result, the EV charger 112 provides power to the EV from the power banks 240 and 250 and this may be similar to that shown in FIG. 3.

Prior to diverting the power, the controller may communicate a shutdown signal to shut down the power banks 240 and 250. Through use of the at least one electrical contactor matrix and the associated controller(s), the shutdown signal is properly routed to shut down the power banks 240 and 250 and this is done prior to diverting power back to the second EV charger to ensure safety.

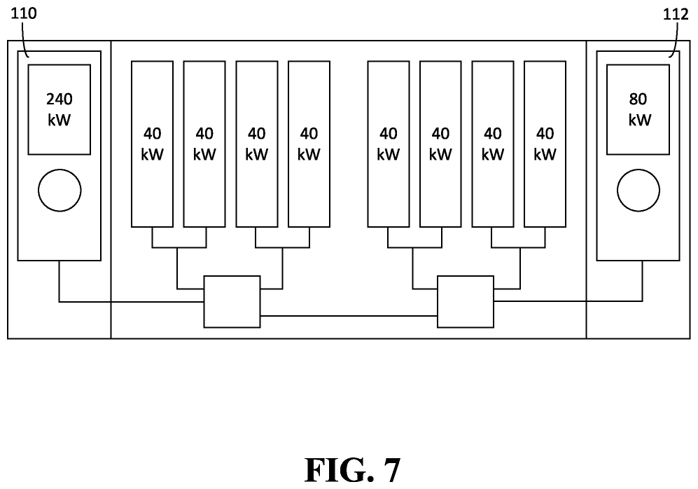

It will be appreciated that in one or more embodiments of the method 600, the controller may determine that all power sources associated with the second EV charger are not required to charge the EV at the maximum rate. For example, it may be determined that the EV is only able to receive 80 kW of power. As such, the controller may determine that only one of the power banks may be required to charge the EV and as such may communicate a signal to the second electrical contactor matrix 260 to electrically couple one of the power banks 240 and 250 to the second EV charger. An example is shown in FIG. 7. As can be seen, the first EV charger is able to provide 240 kW of power to the EV connected thereto while the second EV charger is able to provide 80 kW to the EV connected thereto. In this manner, all power banks within the EV charging station are utilized.

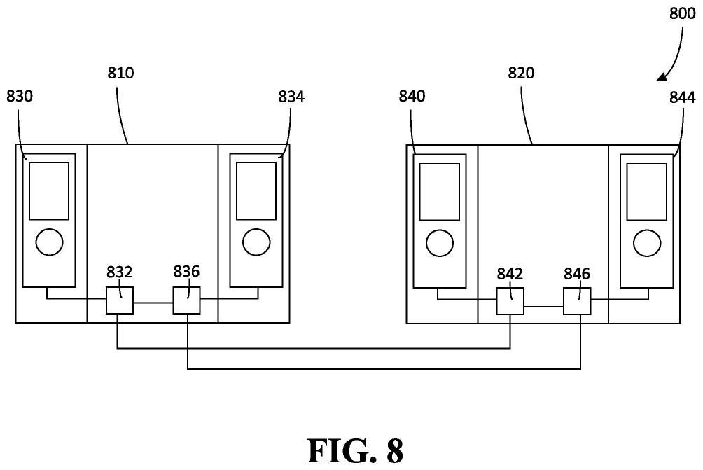

Although in embodiments provided herein the EV charging system is described as including a single EV charging station, it will be appreciated that the EV charging system may include more than one EV charging station. FIG. 8 illustrates an example EV charging system 800 that includes a first EV charging station 810 and a second EV charging station 820. The first EV charging station 810 and the second EV charging station 820 may be similar to the EV charging station 105 described herein. For example, the first EV charging station 810 may include a first EV charger 830 and a first electrical contactor matrix 832 and a second EV charger 834 and a second electrical contactor matrix 836. Although not shown, the first EV charging station 810 may include power banks similar to those of the EV charging station 105 shown in FIG. 2. Specifically, the first EV charging station 810 may include two power banks that are associated with the first EV charger 830 and may include two power banks that are associated with the second EV charger 834. The first electrical contactor matrix 832 and the second electrical contactor matrix 836 may include multiple electrical contactors that may be configured to selectively electrically couple the power banks, EV chargers, and the EV charging stations as required

The second EV charging station 820 may include a third EV charger 840 and a third electrical contactor matrix 842 and a fourth EV charger 844 and a fourth electrical contactor matrix 846. Although not shown, the second EV charging station 820 may include power banks similar to those of the EV charging station 105 shown in FIG. 2. Specifically, the second EV charging station 820 may include two power banks that are associated with the third EV charger 840 and may include two power banks that are associated with the fourth EV charger 844. The third electrical contactor matrix 842 and the fourth electrical contactor matrix 846 may include multiple electrical contactors that may be configured to selectively electrically couple the power banks EV chargers, and the EV charging stations as required.

In the example shown in FIG. 8, the first EV charger 830 may access the power banks of the second EV charger 834 and the third EV charger 840. The second EV charger 834 may access the power banks of the first EV charger 830 and the fourth EV charger 844. The third EV charger 840 may access the power banks of the fourth EV charger 844 and the first EV charger 830. The fourth EV charger 844 may access the power banks of the third EV charger 840 and the second EV charger 834.

The method 400 described herein may be performed by controllers of the EV chargers to divert power. For example, during the execution of the method 400, the controller of the first EV charger 830 may perform the step 410 to identify that the first EV charger of the first EV charging station requires a greater amount of power than can be provided by the power banks associated with the first EV charger. The controller may perform the step 420 to identify at least one other power source as available for use. As described herein, the controller may consult an ordered list of other power sources available to the first EV charger, where the ordered list may define a hierarchy of power banks available to the first EV charger. In the example shown in FIG. 8, the ordered list may define the hierarchy of power banks available to the first EV charger as: (1) power banks associated with the first EV charger, (2) power banks within the first EV charging station or power banks within the same EV charging station as the first EV charger, which may include the power banks of the second EV charger 834, and (3) power banks of the third EV charger 840. As such, the controller may consult the list to determine which power source is available for use and this may be done sequentially. In this example, the controller may determine that all of the power banks associated with the first EV charger are being used, all of the power banks within the first EV charging station are being used, and may determine that power banks of the third EV charger are available for use by the first EV charger. The controller may perform the step 430 to communicate a signal to the controller of the third EV charger to cause the third electrical contactor matrix 842 to divert power from the at least one other power source to the first EV charger. In this example, where the at least one other power source includes at least one power bank associated with the third EV charger, the controller of the third EV charger may communicate a signal to the third electrical contactor matrix 842. In response, the third electrical contactor matrix 842 may execute switching patterns to electrically couple the at least one power bank associated with the third EV charger to the first EV charger.

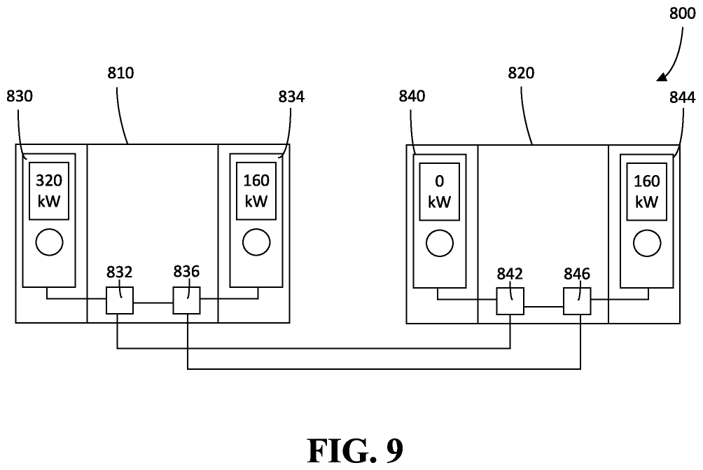

An example is shown in FIG. 9. As can be seen, the first EV charger 830 is able to provide 320 kW of power to the EV connected thereto, the second EV charger 834 is able to provide 160 kW of power to the EV connected thereto, the third EV charger 840 does not have any available power as the additional power provided to the first EV charger 830 is diverted from the power banks associated with the third EV charger 840, and the fourth EV charger 844 is able to provide 160 kW of power to the EV connected thereto.

The method 600 described herein may be performed by controllers of the EV chargers of the first and second EV charging stations to divert power back to the EV charger. For example, in the example shown in FIG. 9, it may be determined that an EV has connected to a third charging cable of the third EV charger 840. The controller of the third EV charger 840 may determine that the power banks associated with the third EV charger 840 are being used by the first EV charger. In response, the controller may communicate a signal to the third electrical contactor matrix 842. In response, the third electrical contactor matrix 842 may execute switching patterns to electrically couple the power banks associated with the third EV charger back to the third EV charger. It will be appreciated that the switching patterns may include delays and/or other safety mechanisms to ensure power is safely diverted.

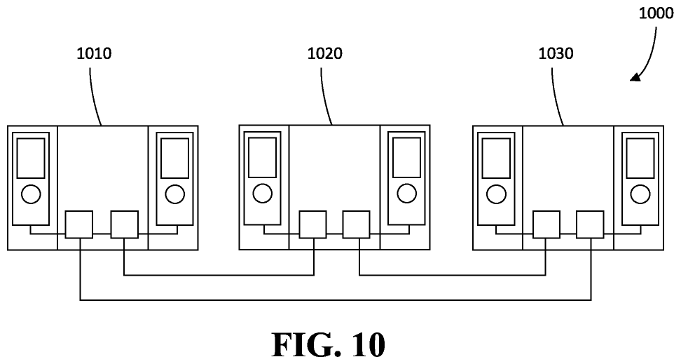

FIG. 10 illustrates another example EV charging system 1000 that includes a first EV charging station 1010, a second EV charging station 1020, and a third EV charging station 1030. The first EV charging station 1010, the second EV charging station 1020 and the third EV charging station 1030 may be similar to the EV charging station 105 described herein. The above described methods 400 and 600 may be performed by the controllers of the first EV charging station 1010, the second EV charging station 1020, and the third EV charging station 1030 to divert power between the EV chargers connected to one another (as shown in FIG. 10) in manners similar to that described herein.

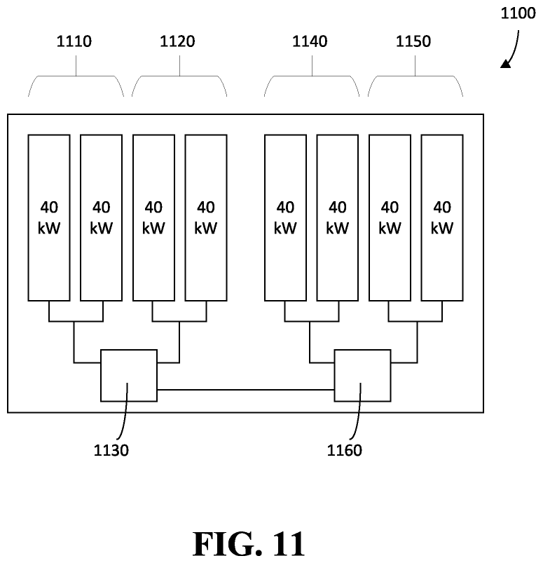

In one or more embodiments, the EV charging system may additionally or alternatively include one or more remote power cabinets that may include power banks available for use to one or more EV chargers. An example power cabinet 1100 is shown in FIG. 11. The power cabinet 1100 houses components similar to that of the power cabinet 150. Specifically, the power cabinet 1100 houses a first power bank 1110, a second power bank 1120, a first electrical contactor matrix 1130, a third power bank 1140, a fourth power bank 1150, and a second electrical contactor matrix 1160. The power cabinet 1100 may include one or more controllers that may communicate with one or more EV charging stations to selectively divert or otherwise provide power to one or more EV chargers as required in accordance with embodiments described herein. The power cabinet 1100 may connect to the DC port of at least one electrical contactor matrix of one or more EV chargers. The power cabinet 1100 may not include a local charging interface and as such may only be used to provide power to one or more external EV chargers.

In embodiments described herein, the charging of a connected EV may be monitored to determine whether or not the connected EV is accepting the additional power from the one or more power sources. For example, power from a power bank associated with a second EV charger may be diverted to charge an EV connected to a first EV charger. It may be determined that the connected EV is not accepting the additional power and as such operations may be performed to divert power from the power bank back to the second EV charger. In this manner, the additional power is only diverted when it is determined that the connected EV is accepting the diverted power.

In manners described herein, through use of the at least one electrical contactor matrix described herein the associated controller(s), the EV charging system 100 may propagate a shutdown signal to all power banks involved in a charge and this may be done for safety reasons. Put another way, through use of the at least one electrical contactor matrix and the associated controller(s), the EV charging system is able to route a shutdown signal to the correct power banks to ensure safe switching.

Although in embodiments described herein an ordered list is described as defining a hierarchy of power banks available to an EV charger, it will be appreciated that in one or more embodiments, an ordered list may additionally or alternatively be maintained that defines a hierarchy of EV chargers for a power bank. For example, the list may define an ordered list or priority list of EV chargers that may be provided access to a particular power bank. The list may define, for example, (1) the EV charger associated with the particular power bank, (2) any EV chargers within the same EV charging station as the power bank, (3) any EV chargers within the same EV charging system as the power bank.

In these embodiments, the list may be consulted in similar manners to that described herein to divert power based on demand at the EV charging system. For example, the list may define a priority list of EV chargers for a first power bank within the first EV charging station. The list may define, for example, (1) the first EV charger associated with the first power bank, (2) the second EV charger within the same EV charging station as the first power bank, (3) any EV chargers within the same EV charging system as the first power bank which may be, for example, a second EV charging station. In this example, it may be that power from the first power bank is diverted to a third EV charger of the second EV charging station. The controller of the first EV charging station may determine that the second EV charger requires a greater amount of power than can be provided by the power banks associated with the second EV charger. The controller may consult the list for the first power bank and may determine that the second EV charger is higher on the priority list than the third EV charger. As such, the controller may communicate a signal to at least one electrical contactor matrix to cause the at least one electrical contactor matrix to stop diverting power from the first power bank to the third EV charger and to start diverting power from the first power bank to the second EV charger.

It will be appreciated that the methods described herein may be performed automatically by the controllers of the EV charging stations every time an EV has established communication with one of the EV chargers. The methods described herein may additionally or alternatively be performed continuously during an EV charge. In this manner, the controllers may automatically divert power to the EV chargers when the EV charging system has one or more power banks that are not currently being used and this may be done to maximize or increase the overall efficiency of usage of the EV charging system.

The controllers described herein in association with the EV charging stations may include a controller on a mainboard of the EV charging station. The controllers may communicate data over a data channel. The data may include power availability data and information about whether a particular EV charger is in use. In this manner, the controller may be enabled to make real-time power diverting decisions based on real-time data obtained over the data channel.

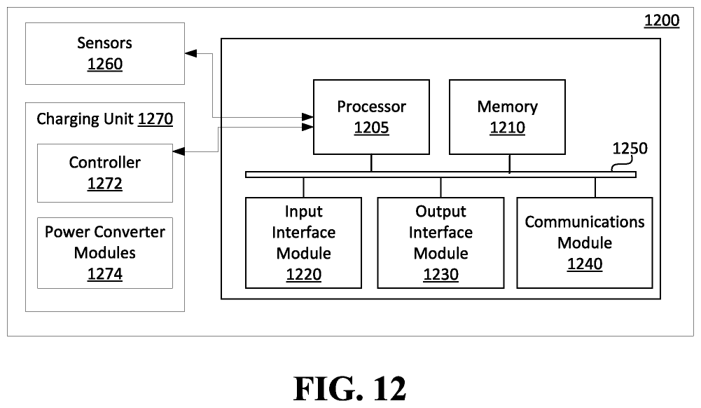

Reference is made to FIG. 12, which is a high-level operation diagram of an example EV charging station 1200. The EV charging station 1200 may be exemplary of the EV charging stations described herein.

The example EV charging station 1200 includes a variety of modules. For example, as illustrated, the example EV charging station 1200, may include a processor 1205, a memory 1210, an input interface module 1220, an output interface module 1230, and a communications module 1240. As illustrated, the foregoing example modules of the example EV charging station 1200 are in communication over a bus 1250.

The processor 1205 is a hardware processor. The processor 1205 may, for example, be one or more ARM, Intel x86, PowerPC processors or the like.

The memory 1210 allows data to be stored and retrieved. The memory 1210 may include, for example, random access memory, read-only memory, and persistent storage. Persistent storage may be, for example, flash memory, a solid-state drive or the like. Read-only memory and persistent storage are a computer-readable medium. A computer-readable medium may be organized using a file system such as may be administered by an operating system governing overall operation of the example EV charging station 1200.

The input interface module 1220 allows the example EV charging station 1200 to receive input signals. Input signals may, for example, correspond to input received from a user. The input interface module 1220 may serve to interconnect the example EV charging station 1200 with one or more input devices. Input signals may be received from input devices by the input interface module 1220. Input devices may, for example, include one or more of a touchscreen input, keyboard, trackball or the like. In some implementations, all or a portion of the input interface module 1220 may be integrated with an input device. For example, the input interface module 1220 may be integrated with one of the aforementioned example input devices.

The output interface module 1230 allows the example EV charging station 1200 to provide output signals. Some output signals may, for example, allow provision of output to a user. The output interface module 1230 may serve to interconnect the example EV charging station 1200 with one or more output devices. Output signals may be sent to output devices by output interface module 1230. Output devices may include, for example, a display screen such as for example a liquid crystal display (LCD), a touchscreen display. Additionally, or alternatively, output devices may include devices other than screens such as, for example, a speaker, a surveillance camera, an operator terminal, indicator lamps (such as for example light-emitting diodes (LEDs)), and printers. In some implementations, all or a portion of the output interface module 1130 may be integrated with an output device. For example, the output interface module 1230 may be integrated with one of the aforementioned example output devices.

The communications module 1240 allows the example EV charging station 1200 to communicate with other electronic devices and/or various communications networks. For example, the communications module 1240 may allow the example EV charging station 1200 to send or receive communications signals. Communications signals may be sent or received according to one or more protocols or according to one or more standards. For example, the communications module 1240 may allow the example EV charging station 1200 to communicate via a cellular data network, such as for example, according to one or more standards such as, for example, Global System for Mobile Communications (GSM), Code Division Multiple Access (CDMA), Evolution Data Optimized (EVDO), Long-term Evolution (LTE) or the like. The communications module 1240 may allow the example EV charging station 1200 to communicate using near-field communication (NFC), via Wi-Fi™, using Bluetooth™ or via some combination of one or more networks or protocols. Contactless payments may be made using NFC. In some implementations, all or a portion of the communications module 1240 may be integrated into a component of the example EV charging station 1200. For example, the communications module may be integrated into a communications chipset.

Software comprising instructions is executed by the processor 1205 from a computer-readable medium. For example, software may be loaded into random-access memory from persistent storage of memory 1210. Additionally, or alternatively, instructions may be executed by the processor 1205 directly from read-only memory of memory 1210.

The EV charging station 1200 may also include a plurality of sensors 1260 such as, without limitation, accelerometers, gyroscopes, tilt indicators, cameras, etc. In at least some implementations, one or more of the sensors 1260 may be contained in a housing associated with the EV charging station 1200. In particular, at least one sensor 1260 that is configured to measure motion (e.g., acceleration, angular velocity, etc.) of a structure may be housed within the EV charging station 1200. One or more charging units 1270 may be included in the EV charging station 1200. The charging units 1270 may, in some implementations, be controlled by a controller 1272 which may be different from the processor 1205. The charging units 1270 may each include at least one power converter module 1274, such as an AC-to-DC converter.

The various implementations presented above are merely examples and are in no way meant to limit the scope of this application. Variations of the innovations described herein will be apparent to persons of ordinary skill in the art, such variations being within the intended scope of the present application. In particular, features from one or more of the above-described example implementations may be selected to create alternative example implementations including a sub-combination of features which may not be explicitly described above. In addition, features from one or more of the above-described example implementations may be selected and combined to create alternative example implementations including a combination of features which may not be explicitly described above. Features suitable for such combinations and sub-combinations would be readily apparent to persons skilled in the art upon review of the present application as a whole. The subject matter described herein and in the recited claims intends to cover and embrace all suitable changes in technology.

What is claimed is:

1. An electric vehicle (EV) charging system comprising:
at least a first EV charging station that includes at least a first EV charger and at least one power bank associated with the first EV charger;
at least one electrical contactor matrix associated with the first EV charger and selectively coupling the first EV charger to the at least one power bank associated with the first EV charger and to at least one other power source; and
a controller associated with the first EV charger, the controller configured to:
determine that the first EV charger requires a greater amount of power than can be provided by the at least one power bank associated with the first EV charger;
identify the at least one other power source as available for use; and
communicate a signal to divert power from the at least one other power source to the first EV charger.

2. The EV charging system of claim 1, wherein the at least one other power source includes at least one of an internal power source or an external power source.

3. The EV charging station of claim 2, wherein the external power source includes at least one of a power bank of at least one other EV charging station or a power bank of a remote power cabinet.

4. The EV charging system of claim 1, wherein the first EV charging station includes at least one other power bank associated with the first EV charger and the at least one other power source includes the at least one other power bank associated with the first EV charger.

5. The EV charging system of claim 1, wherein the first EV charging station includes at least a second EV charger and at least one power bank associated with the second EV charger and the at least one other power source includes the at least one power bank associated with the second EV charger.

6. The EV charging system of claim 5, wherein when identifying the at least one other power source as available for use, the controller is configured to:
determine that the at least one power bank associated with the second EV charger is available for use; and
communicate a signal to a controller associated with the second EV charger to cause at least one electrical contactor matrix associated with the second EV charger to divert power from the at least one power bank associated with the second EV charger to the first EV charger.

7. The EV charging system of claim 5, further comprising:
at least a second EV charging station that includes at least a third EV charger and at least one power bank associated with the third EV charger and the at least one other power source includes the at least one power bank associated with the third EV charger.

8. The EV charging system of claim 7, wherein the second EV charging station includes at least a fourth EV charger and at least one power bank associated with the fourth EV charger and the at least one other power source includes the at least one power bank associated with the fourth EV charger.

9. The EV charging system of claim 7, wherein when identifying the at least one other power source as available for use, the controller is configured to:
determine that the at least one power bank associated with the second EV charger is not available for use;
determine that at least one power bank associated with the third EV charger is available for use; and
communicate a signal to a controller associated with the third EV charger to cause at least one electrical contactor matrix associated with the third EV charger to divert power from the at least one power bank associated with the third EV charger to the first EV charger.

10. The EV charging system of claim 1, wherein when identifying the at least one other power source as available for use, the controller is configured to analyze the first EV charging station to determine that one or more other power banks within the first EV charging station are available for use.

11. The EV charging system of claim 1, wherein when identifying the at least one other power source as available for use, the controller is configured to maintain an ordered list of other power sources available for the first EV charger and to consult the ordered list to identify the at least one other power source as available for use.

12. The EV charging station of claim 11, wherein the ordered list defines a hierarchy of power banks available to the first EV charger.

13. The EV charging system of claim 1, wherein when determining that the first EV charger requires the greater amount of power than can be provided by the at least one power bank associated with the first EV charger, the controller is configured to:
communicate with a connected EV to obtain battery statistics of the EV;
determine a maximum power for charging the EV based on the battery statistics of the EV; and
determine that the maximum power for charging the EV is greater than an amount of power that can be provided by the at least one power bank associated with the first EV charger.

14. The EV charging system of claim 1, wherein the first EV charger has priority to the at least one power bank associated with the first EV charger.

15. A method comprising:
determining that a first electric vehicle (EV) charger of a first EV charging station requires a greater amount of power than can be provided by at least one power bank associated with the first EV charger;
identifying at least one other power source as available for use; and
communicating a signal to divert power from the at least one other power source to the first EV charger.

16. The method of claim 15, wherein the first EV charging station includes at least one other power bank associated with the first EV charger and the at least one other power source includes the at least one other power bank associated with the first EV charger.

17. The method of claim 15, wherein when identifying the at least one other power source as available for use, the method further comprises:
determining that at least one power bank associated with a second EV charger of the first EV charging station is available for use; and
communicate a signal to a controller associated with the second EV charger to cause at least one electrical contactor matrix associated with the second EV charger to divert power from the at least one power bank associated with the second EV charger to the first EV charger.

18. The method of claim 15, wherein when identifying the at least one other power source as available for use, the method further comprises:
determining that at least one power bank associated with a second EV charger of the first EV charging station is not available for use;
determining that at least one power bank associated with a third EV charger of a second EV charging station is available for use; and
communicate a signal to a controller associated with the third EV charger to cause at least one electrical contactor matrix associated with the third EV charger to divert power from the at least one power bank associated with the third EV charger to the first EV charger.

19. The method of claim 15, wherein when identifying the at least one other power source as available for use, the method further comprises:
analyzing the first EV charging station to determine that one or more other power banks within the first EV charging station are available for use.

20. The method of claim 15, further comprising:
consulting an ordered list of other power sources available for the first EV charger to identify the at least one other power source as available for use.
